(19) United States
(12) Patent Application Publication
(10) Pub. No.: US 2005/0002548 A1
(43) Pub. Date: Jan. 6, 2005

(54) Automatic detection of growing nodules

(76) Inventors: Carol L. Novak, Newtown, PA (US); Hong Shen, Princeton, NJ (US); Benjamin Odry, West New York, NJ (US)

Correspondence Address: Siemens Corporation;Intellectual Property Department, 170 Wood Avenue South, Iselin, NJ, 08830, US

(21) Appl. No.: 10/869,291

(22) Filed: Jun. 16, 2004

Related U.S. Application Data
(60) Provisional application No. 60/480,247, filed on Jun. 20, 2003.

(51) Int. Cl. G06K 9/00; G06K 9/68

(52) U.S. Cl. 382/128; 382/218

(57) ABSTRACT

A system and method for detecting a growing nodule in multi-slice data detects a nodule candidate in a later scan, and matches a location of the nodule candidate in the later scan to a location in an earlier scan, wherein the earlier and later scans are of the same patient. The system and method segments the nodule candidate in the earlier and later scans, compares volumes from each segmentation, and determines a nodule, wherein the nodule is determined to be larger or newly appeared in the later scan as compared to the earlier scan.

### BACKGROUND OF THE INVENTION

1. Field of the Invention

The present invention relates to volumetric medical image data, and more particularly to a system and method for automatic detection of growing or new nodules.

2. Discussion of Related Art

Lung cancer is the leading cause of cancer death in the United States and around the world. Despite decades of research into cancer treatment, the prognosis for patients diagnosed with lung cancer is very dismal, with an average 5-year survival rate of just 14%. Early stages of lung cancer do not usually cause specific symptoms, and most patients are diagnosed at advanced stages. However for those patients who are diagnosed in stage I, the prognosis is much better, with average 5-year survival rates of 60-70%. Lung cancer screening offers the most promising option for detecting cancer in the early stages when cure is most likely.

Lung cancer screening by computed tomography (CT) has been shown to increase the percentage of cancers detected in stage I when compared with chest x-ray screening. CT allows the detection of smaller tumors compared with chest x-rays, and multi-slice CT allows the detection of smaller tumors than single slice CT. However the large datasets associated with multi-slice CT represent an increasing workload for radiologists. Isotropic datasets acquired by the current generation of multi-slice machines may have 600 images per patient scan.

The lungs contain complex structures of branching vessels and airways. Lung nodules may be found throughout the lungs, including attached to the pleura or to vessels. Although larger and more peripheral nodules are relatively easy for radiologists to find, smaller and more central nodules may be missed even by skilled radiologists.9 Computer aided detection of nodules promises to reduce the number of missed nodules.

However the vast majority of small nodules detected by radiologists during screening are benign. The International Early Lung Cancer Action Program (I-ELCAP) protocol for lung cancer screening by CT specifies that nodules below 5 mm in diameter detected during an initial screening receive no special follow-up other than the normal yearly screening. However the same protocol specifies that even 3 mm nodules that have newly appeared since the prior scan should receive earlier follow-up. Similarly, small nodules that have grown since the previous scan also warrant attention. The American College of Radiology Imaging Network (ACRIN) trial of screening for lung cancer protocol also makes a distinction between nodules seen at the first screen and nodules that are enlarging.

There are several research groups investigating automatic detection of lung nodules. Most such research has been applied to finding nodules from a single CT volume, although there have been a small number of systems developed for nodule follow-up. Although the existence of a single scan is the usual scenario for patients entering a screening program, for those patients who are ongoing participants in a program, prior scans will be available for comparison. In addition, cancer patients who are being followed for known or suspected lung metastases also may receive sequential CT exams, and the detection of new or growing lung nodules is of critical importance in these cases.

Therefore, a need exists for a system and method for automatic detection of growing or new nodules.

### SUMMARY OF THE INVENTION

A method for detecting a nodule in volumetric medical image data includes detecting a nodule candidate in a later scan, matching a location of the nodule candidate in the later scan to a location of the nodule candidate in an earlier scan, wherein the earlier and later scans are of the same patient, and segmenting the nodule candidate in the earlier and later scans. The method includes comparing volumes from each segmentation and determining a growing nodule, wherein the nodule is determined to be larger or newly appeared in the later scan as compared to the earlier scan.

Detecting the nodule candidate in the later scan includes determining voxels in the later scan with densities corresponding to solid tissue as seed points,
determining a threshold for segmenting the seed points from a background in the later scan, and comparing the seed points to known parameters of nodules to determine the presence of the nodule candidate.

Detecting the nodule candidate in the later scan includes determining seed points by principal components analysis, performing a volume projection to reduce the data dimension of the seed points from three to one, and comparing the seed points to known parameters of nodules to determine the presence of the nodule candidate.

Matching the location of the nodule candidate in the later scan to the location of the nodule candidate in the earlier scan includes determining an area of a lung on a 2D slice in each of the earlier and the later scan, determining a curve for the set of lung areas for the earlier scan and a cruve for the set of lung areas for the later scan, and determining a linear equation for fitting a curve for the earlier and a curve of later scan. The method further includes determining an X, Y, or Z displacement in the earlier scan according to an X, Y, or Z displacement in the later scan according to the curve, and determining the location of the nodule candidate in the earlier scan from the location of the nodule candidate in the later scan, wherein the location is an (x,y,z) coordinate. The method includes selecting the location in earlier scan is to be refined, forming surface maps around the location in the earlier scan and the location in the later scan, and determining a new (x,y,z) coordinate in the earlier scan having a surface map determined to match the surface map of the later scan more closely than the location in the earlier scan previously determined.

Segmenting the nodule candidate in the earlier and later scans includes separating the nodule candidate from a background, determining a core of the nodule, determining a template around the core, and segmenting the scan according to the template.

The method includes determining a density of each nodule candidate, and removing nodule candidates from the list of growing nodule candidates determined to have a density above a predetermined density threshold.

The method includes determining a size variance for each nodule candidate between the earlier scan and the later scan, and removing nodule candidates from the list of growing nodule candidates determined to have a size variance less than a predetermined size variance threshold.

A program storage device is provided, readable by machine, tangibly embodying a program of instructions executable by the machine to perform method steps for detecting a nodule in volumetric medical image data. The method includes detecting a nodule candidate in a later scan, matching a location of the nodule candidate in the later scan to a location of the nodule candidate in an earlier scan, wherein the earlier and later scans are of the same patient, segmenting the nodule candidate in the earlier and later scans, comparing volumes from each segmentation, and determining a growing nodule, wherein the nodule is determined to be larger or newly appeared in the later scan as compared to the earlier scan.

A system for detecting a nodule in volumetric medical image data includes a nodule candidate detection module, detecting a nodule candidate in a later scan, a matching module, matching a location of the nodule candidate in the later scan to a location of the nodule candidate in an earlier scan, wherein the earlier and later scans are of the same patient, and a segmentation module, segmenting the nodule candidate in the earlier and later scans and comparing volumes from each segmentation, wherein a nodule is determined to be present upon determining the nodule candidate to be larger or newly appeared in the later scan as compared to the earlier scan.

The nodule detection module includes a solitary module detecting solitary nodules, a pleura-attached module detecting pleura-attached nodules, and a vessel attached module detecting vessel-attached nodules. The system includes a false-positive module for removing false positive results from the list of nodule candidates as determined by one or more of the solitary module, the pleura-attached module and the vessel attached module.

The system includes a classification module for classifying nodule candidates of the segmentation module. The classification module determines a density of each nodule candidate, and removes nodule candidates from the list of growing nodule candidates determined to have a density above a predetermined density threshold. The classification module determines a size variance for each nodule candidate between the earlier scan and the later scan and removes nodule candidates from the list of growing nodule candidates determined to have a size variance less than a predetermined size variance threshold.

A method for classifying nodule candidates includes receiving a nodule candidate, determining a size variance on the nodule candidate between at least two scans taken at different times, classifying the nodule candidate as a nodule of interest upon determining the size variance to be greater than a threshold, determining a density of the nodule candidate in the at least two scans, and classifying the nodule candidate as a nodule of interest upon determining the density of the nodule candidate to be less than a predetermined density threshold in the at least two scans.

### BRIEF DESCRIPTION OF THE DRAWINGS

Preferred embodiments of the present invention will be described below in more detail, with reference to the accompanying drawings:

FIGS. 1A-1D are flow charts of a method according to an embodiment of the present disclosure;

FIG. 2 is an illustration of a system according to an embodiment of the present disclosure;

FIG. 3 is a diagram of a nodule detection system according to an embodiment of the present disclosure;

FIG. 4A is a graph of results for an automatic classification of nodule candidate characteristics according to an embodiment of the present disclosure;

FIG. 4B is a graph showing ground truth results for automatic detection of growing nodules;

FIGS. 5A and 5B are scans of a patient at two different times;

FIGS. 5C and 5D are segmentation results corresponding to FIGS. 5A and 5B, respectively;

FIGS. 6A and 6B are scans of a patient at two different times; and

FIGS. 6C and 6D are segmentation results corresponding to FIGS. 6A and 6B, respectively.

### DETAILED DESCRIPTION OF PREFERRED EMBODIMENTS

A method for detecting growing lung nodules uses the availability of prior scans to target the detection of precisely those nodules that are at highest likelihood of malignancy due to demonstrated growth.

The method detects nodule candidates in the later of two scans of a patient 101. Locations in one scan are matched with the corresponding locations in another scan of the same patient 102. Once the location for the candidate in each of the two scans has been determined, an automatic method for nodule segmentation is applied to the voxels around each location 103. The volumes from each segmentation result are compared 104. A list of candidate nodules is generated where the nodule is determined to be larger or newly appeared since the previous scan 105.

The system and method operate on two multi-slice scans of the same patient taken at different times.

For each of patient an automatic detection program is applied to the later study. This gives a set of candidate nodules P. The follow-up program for each nodule in set P is used to find the automatically determined matching location in the prior scan. This gives rise to a set of matching locations Q.

A small search window around each matching location is used to search for an object. If an object is found location Q is modified to that position. For each nodule candidate in P and the matching location in Q, the automatic segmentation location is applied to the locations. This gives rise to a set of measured volumes: V={v₁, v₂ . . . vₙ} and W={w₁, w₂ . . . wₙ}, where V describes the volumes of the nodule candidates in the later scan. W describes the volumes of the nodules as they appeared in the earlier scan, although some values may be 0 if the nodule was not found in the earlier scan.

If the matching location lands on air voxels, then the segmentation program will return a volume of zero. In this case the program assumes that the nodule is newly appeared.

The number of false positives may be reduced. The sphericity of the two segmented objects at locations P and Q are determined. These give rise to confidence values that the object is truly a nodule. Although the confidence of the object at Q can be low, in case the nodule is newly appeared, the confidence at location P should be strong. If it is not, that candidate is eliminated from consideration.

Further, calcified nodules are inherently benign and thus may be ignored. For each nodule or nodule-like object that is segmented, the percentage of it that is calcified is determined by counting the number of voxels above the calcium threshold (C) and dividing it by the total number of voxels in the object. If the percentage of calcium exceeds the calcified percentage (Cₚ) then the candidate is eliminated from consideration.

A threshold for growth (G) is selected, and the set of nodules is automatically determined where significant growth occurred. The output of the system is the set of nodules not eliminated in the false positive reduction step, where the change in computed volume exceeds G.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

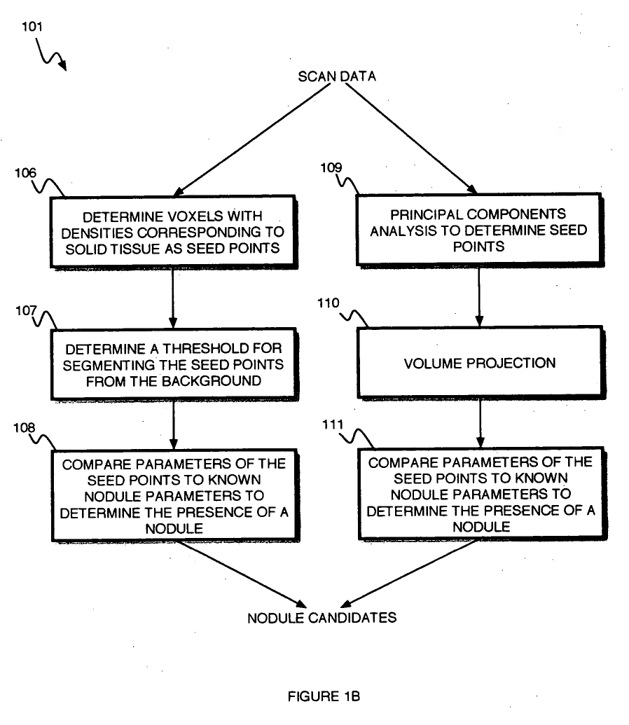

Referring to FIG. 2, according to an embodiment of the present invention, a computer system 201 for implementing the present invention can comprise, inter alia, a central processing unit (CPU) 202, a memory 203 and an input/output (I/O) interface 204. The computer system 201 is generally coupled through the I/O interface 204 to a display 205 and various input devices 206 such as a mouse and keyboard. The support circuits can include circuits such as cache, power supplies, clock circuits, and a communications bus. The memory 203 can include random access memory (RAM), read only memory (ROM), disk drive, tape drive, etc., or a combination thereof. The present invention can be implemented as a routine 207 that is stored in memory 203 and executed by the CPU 202 to process the signal from the signal source 208, such as a CT scanner. As such, the computer system 201 is a general-purpose computer system that becomes a specific purpose computer system when executing the routine 207 of the present invention.

The computer platform 201 also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Although the set of nodules reported by the system will be smaller than the nodules originally detected, those reported nodules would be of greater clinical significance. It is well known that the majority of nodules detected during screening are benign. Some estimates put this percentage at 99%. However, nodules that exhibit growth are inherently much more suspicious. Thus it is highly important to call attention to this subset of nodules. Also, although there will be some false positives (nodules that aren't truly growing) the potential payoff of finding those that really are growing is sufficiently high as to justify the time spent examining the false positives.

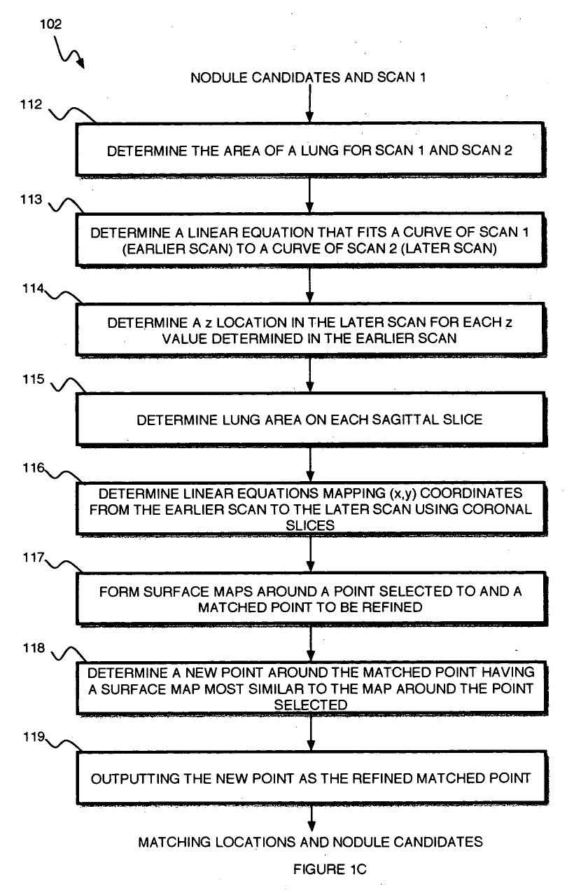

Various methods for detecting lung nodules from a single scan may be used. In a preferred embodiment of the disclosure, nodules are discovered using a “divide-and-conquer” approach to finding different sub-types of nodules. Referring to FIG. 3, the nodule detection method 101 implements modules for solitary nodules 301, pleura-attached nodules 302, and vessel-attached nodules 303. The different tasks and the outputs are combined and filtered. Other modules may be implemented, for example, for removing a particular class of false positives 304. The modular approach makes the system extensible to handle the detection of additional types of nodules, such as ground glass nodules.

An automatic detection method is applied to lung segments taken from the CT volume using three-dimensional (3D) region growing. With the chest wall is removed, the method may focus on the structures within the lungs. A surface-smoothing module, based on the rolling ball algorithm, may be used to detach nodules from the pleura. Thus, nodules that may be attached to the chest wall are not removed. The detached pieces may be analyzed to determine whether they meet criteria for nodules, for example, having predetermined intensity, volume, and/or shape.

The detection of nodules 101 within a scan may use different techniques for solitary nodule candidates and vessel-attached nodule candidates. An adaptive local histogram analysis is used to detect nodules that are not attached to any structures, or those that are no longer attached to the chest wall after the segmentation. Those voxels with densities corresponding to solid tissue are seed points for possible nodules 106. Densities for different types of tissues are known in the art. The density histogram of a local volume around each seed point is analyzed to determine a threshold for segmenting the structure from the background 107. Properties of the resulting segmented object, including size, shape and density, are analyzed to determine whether they are nodule-like 108.

For those nodules that have a firm connection to vessels, using a threshold may not satisfactorily segment the nodule away from the vessel while leaving the nodule relatively intact. To detect this class of nodules, a principal components analysis 109 may be implemented followed by volume projection 110 to reduce the data dimension from three to one, making the search for possible vessel-attached nodules efficient.

The principal components analysis 109 is described in U.S. patent application Ser. No. 20030105395, entitled “Vessel-Feeding Pulmonary Nodule Candidate Generation”, filed on Dec. 5, 2001, the disclosure of which is hereby incorporated by reference in its entirety. The system and method 109 include a volume examination unit for providing a plurality of images defining a lung volume and examining the lung volume to generate a list of seed objects. A VOI generator selects a seed object from the list and defines a VOI comprising the seed object within the lung volume. A seed examination unit extracts a structure of interest comprising the seed object from the VOI, analyzing the structure of interest by automatically quantifying features therein, and updating the list of seed objects to exclude all unexamined seed objects contained in the current structure of interest under examination. A candidate generator generates a candidate from the structure of interest if its features meet preset criteria and providing geometric characteristics of the candidate to other algorithms for detecting pulmonary nodules.

Volume projection 110 is an operation that transforms a 3-dimensional volume data into a 1-dimensional profile or curve. Methods for volume projection are described in U.S. patent application Ser. No. 20030103664, entitled “Vessel-Feeding Pulmonary Nodule Detection by Volume Projection Analysis”, filed on Dec. 5, 2001, the disclosure of which is hereby incorporated by reference in its entirety. The volume projection data transform 110 converts the needed morphological and diagnostic information of an object of interest (e.g., nodule candidate) into a form with which a computer can more reliably perform the detection, and significantly simplifies the analysis of the volume shape. For volume projection the VOI is denoted by V(x,y,z), where the z-axis is the scanning direction, which is along the long axis of the human body, and the x-y plane corresponds to a cross-section of the image data for the human body. The volume as smoothed by scale sεs is denoted by Iₛ(x,y,z) . For each of the smoothing scale sεs, a cylinder Cᵣ(x,y,z) of radius rₛ is generated. As an example, for s={0,3,5} voxels, the radius rₛ may be chosen as rₛ={3,5,7}. The cylinder is centered on the seed point and is oriented along the z-axis of the volume I_{s,k}(x,y,z). The volume projection P is the summation of the volume intensity on each cross-section of the cylinder along the z-axis, expressed as, for example:

$${P}_{s , k} ( z ) = {\sum }_{x , y ∈ {C}_{r} ( x , y , z )} {I}_{s , k} ( x , y , z )$$

The 1D signatures of possible candidates are analyzed to determine whether they meet criteria for nodules 111, including, for example, a predefined intensity, volume, and/or shape.

An example of an automatic nodule detection method is described in U.S. patent application Ser. No. 20020028008, entitled “Automatic detection of lung nodules from high resolution CT images”, filed on Apr. 23, 2001, the disclosure of which is incorporated herein by reference in its entirety. The method includes defining a volume of interest (VOI) for a lung volume in a CT image. The lung volume is examined using the VOI, including, determining a local histogram of intensity and adaptive threshold values for segmenting the VOI to obtain seeds. Each seed is examined to detect lung nodules therefrom, including segmenting anatomical structures represented by the seed by applying a segmentation method that adaptively adjusts a segmentation threshold value based on histogram analysis of the seed to extract the structures based on three-dimensional connectivity and histogram intensity information, and classifying each structure as a lung nodule or a non-nodule based on a priori knowledge corresponding to lung nodules and related structures. The lung nodules are displayed. The lung nodules are analyzed, including automatically quantifying lung nodule features to provide an automatic detection decision.

The candidates generated by the nodule detection procedures 101 are filtered by sequential rules to remove different non-nodule structures. For example, small thickenings of the bronchial walls may appear as nodules due to the fact that the walls of the bronchi are very thin and subject to partial volume effect. Therefore, a filter for specifically detecting this pattern may eliminate these candidates from further consideration.

In a system for detecting growing nodules, the stand-alone nodule detection method 101 is applied to the later of two patient studies, generating a list of candidate nodules. Subsequent processing steps attempt to localize each of the nodule candidates in the prior study to determine whether it was present, and if so, the relative volumes.

Further, methods may be implemented for reduced false-positives in nodule detection, for example, as described in U.S. patent application Ser. No. 20030144598, entitled “Bronchial Wall Thickening Recognition for Reduced False Positives in Pulmonary Nodule Detection”, filed on Jan. 29, 2002, incorporated herein by reference in its entirety. False-positive nodule candidates associated with airways may be eliminated by testing for airway cavities connected to the candidate, and recognizing the candidate as a false-positive nodule candidate if it is connected to an airway cavity, where the testing may include perpendicular testing for airways that are relatively perpendicular to an examination plane and parallel testing for airways that are relatively parallel to an examination plane.

The method includes an automatic nodule matching module 102. A method for finding matching locations of nodules in two CT scans of the same patient is implemented, for example, as described in Shen H, Fan L, Qian J, Odry BL, Novak CL, Naidich DP, “Real-time and automatic matching of pulmonary nodules in follow-up multi-slice CT studies”, International Conference on Diagnostic Imaging and Analysis (ICDIA), J Qian, S. Schaller, S Zhang editors, Proceedings of the ICDIA, 2002; and U.S. Pat. No. 6,738,063, entitled Object-Correspondence Identification Without Full Volume Registration, filed on Feb. 7, 2002. Two image sets are roughly aligned, and a point in one image set is selected. A rough matching point is located in a second image, a first VOI is defined around the selected point, and a search window is defined around the matching point comprising a plurality of neighboring points. For each point in the search window, a second VOI is defined, the similarity between each of the second VOI with the first VOI is determined, and a second VOI that is most similar to the first VOI is selected.

The system may be used as an interactive aid for radiologists evaluating nodule growth. The user clicks on a nodule location in one of the studies, and the system determines the matching location in the other study. The system can equally well match earlier to later scans and vice versa. And although the system was designed for nodule surveillance, it can match any solid structure within the lungs. The matching method 102 determines an approximate global registration of the entire lungs, followed by refinement of specific positions upon request.

For the initial approximate global registration, the matching module 102 determines an approximate global registration or alignment of the lungs between the two time periods. The global alignment is performed with a linear model, needing scale and shift as parameters. To estimate the parameters, the lungs are segmented from the rest of the volume. The segmentation method 107 used for automatic detection 101 can be used here, although it is also possible to use a different segmentation procedure since possible pleura-attached nodules do not need to be preserved.

The area of the left lung is automatically determined for each axial slice of the earlier and later scans 112. The area values for the slices form a curve describing how the lung cross-sectional area grows and shrinks as analysis proceeds from head to foot. The method determines an optimal linear equation that gives the best fit between the curves for the earlier and later scans 113. This gives rise to an equation that for any given vertical displacement in the earlier scan of the left lung generates a corresponding vertical displacement in the later scan 114. The procedure is repeated for the right lung areas in the earlier and later scans.

The lung areas on each sagittal slice are determined from the same initial segmentation 115. The data is analyzed with coronal slices 116. This gives rise to sets of linear equations mapping x and y values in the earlier scan to corresponding values in the later scan. Again the left and right lung alignments are represented with separate equations.

Slight changes in patient orientation in the scanner may cause the optimal linear alignment for the left lung to be different from that of the right lung. Determining separate equations for the left and right sides allow for a better global alignment.

After the global alignment is determined, a local match refinement for requested locations is employed. For each location p to be matched, the method determines an approximate match location q′ in the other scan by using the linear approximations. If the location to be matched occurs in the later study, then the approximate match location in the earlier study is given by the inverse linear equations.

The system forms surface maps around points p and q′ 117. The system searches locally around point q′ to determine the point q that has a surface map most similar to that around p 118. The system outputs the point q as the refined matching location to p 119.

Although this method for nodule matching depends upon similarity of local structures within the lungs, experiments have showed that it works well even when the nodule has changed size dramatically or when the nodule was not previously present. Although the nodule itself may change, the surrounding structures may have sufficient similarity that the method for determining the match location will work reliably. The method is robust to variations in scanning parameters between the two scans, including differences in resolution and radiation dose.

In the growing nodule detection system this process is repeated for each nodule candidate output by the automatic nodule detection system. The output of this phase of the system is a set of location pairs P={p₁, p₂ . . . pₙ} and Q={q₁, q₂ . . . qₙ} where P is the set of locations of possible nodules automatically detected in the later scan, and Q is the set of automatically matched locations in the earlier scan. These paired sets are the input to the nodule segmentation module 103 where the nodules are segmented and measured.

For nodule segmentation and measurement 103, a method is implemented for automatic segmentation of lung nodules from CT, using dynamic cross-correlation with a sphere shaped template. For example, as described by Fan L, Qian J, Odry B L, Shen H, Naidich D P, Kohl G, Klotz E, “Automatic segmentation of pulmonary nodules by using dynamic 3D cross-correlation for interactive CAD systems”, Medical Imaging 2002; M Sonka and M J Fitzpatrick, editors; Proceedings of SPIE 4684: 1362-9, 2002. A method of nodule segmentation is described in U.S. patent application Ser. No. 20030048936, entitled, “Real Time Interaction Segmentation of Pulmonary Nodules with Control Parameters,” filed on Sep. 7, 2001, incorporated herein by reference in its entirety. Given a location within a lung nodule candidate, the nodule is separated from the background and the chest wall is removed if present 120. The core of the nodule and an optimal template around that core 121 is determined, and the template is used to segment away any attached blood vessels 122. Once the nodule is separated from attachment points, its volume and other characteristics can be determined.

Given an initial seed point, the segmentation module 103 constructs a local volume around it. All voxels above soft tissue density that are connected to that seed point are retained. The segmentation module 103 determines whether the object is connected to the chest wall by using reasoning about the relative size of the object and the background. If it is determined that the chest wall is present within the volume, it may be removed by a rolling ball method. However, in this case the chest wall is only excluded from the local volume around the object of interest, rather than from the entire lung volume.

After isolation of the object from the background and chest wall 120, what remains is the nodule and any attached vessels. The core of this structure is determined by morphological opening, and a spherical template is determined centered on the core 121. The segmentation module 103 iteratively increases the template in radius with the cross correlation determined at each increment. The curve of the cross correlation values is analyzed to determine an optimal value. An optimal template is used to retain the nodule and segment away attached vessels 122.

The segmentation module 103 determines a list of voxels that are included within the nodule indicated by the initial point. From this voxel list, the properties of the segmented nodule may be determined, including volume, diameter, and mean density. For the purposes of the growing nodule detection system, the percentage of the nodule that is calcified may also be determined. The percentage calcification is used in the reasoning stage for determining which nodules are potentially growing.

The segmentation module 103 is applied both to the list of locations P corresponding to the automatically detected nodule candidates in the later scan, and the list of locations Q corresponding to the automatically matched locations in the earlier scan. The locations P always fall on a solid object within the scan, as this is one of the properties of the automatic detection method. However, the locations within Q may or may not fall within a solid object. If a nodule detected in the later scan at location pᵢ was not present in the earlier scan, the location qᵢ is expected to be a voxel with density corresponding to air. Accordingly, in this case, the segmentation module 103 returns a zero-length list of voxels, and the volume for that nodule match is set to zero.

The output of this module is two sets of volume measurements: V={v₂, v₁ . . . vₙ} and W={w₁, w₂ . . . wₙ}, where V describes the volumes of the nodule candidates in the later scan. W describes the volumes of the nodules as they appeared in the earlier scan, although some values may be 0 if the nodule was not found in the earlier scan.

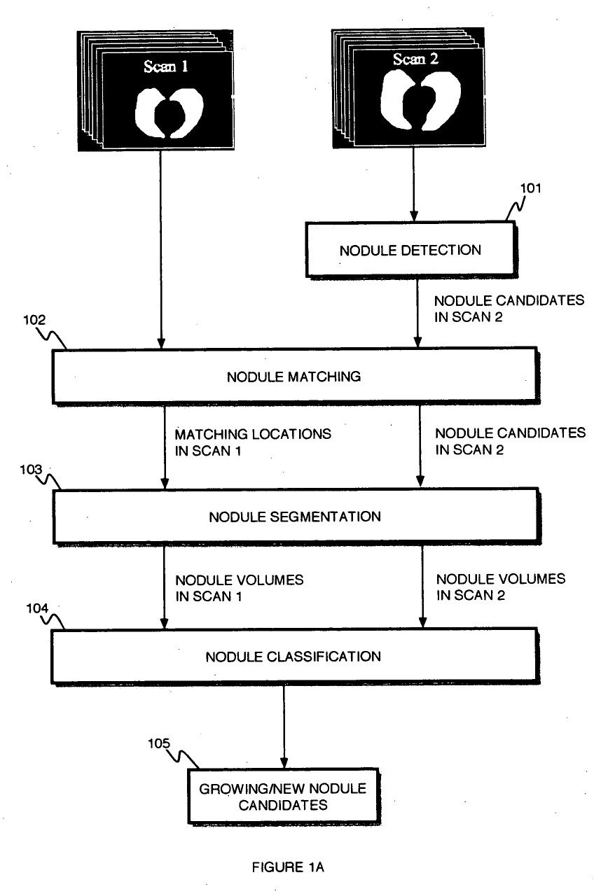

After applying the nodule detection module 101, the nodule matching module 102 and the nodule segmentation nodule 103, the method applies reasoning about the results of the prior stages for nodule classification 104 (see FIG. 1E). The reproducibility of the nodule size measurements has been tested by applying the method to a patient scanned twice in the same day. In that experiment it was found that the maximum variance in nodule measurements between scans on the same day was 4.4 cubic mm 123. In one experiment, twice this value (8.8 cu mm) was selected as the threshold for concluding that nodule growth had occurred 123.

To reduce false positives due to possible errors in volume estimation, the method also estimates the calcification status of each nodule 124. For example, if at least 5% of the voxels in a nodule have density above 200 HU, the method classifies that scan of the nodule as calcified 124. If the nodule is classified as calcified in either of the two scans, it is eliminated from consideration as a growing nodule. In one test, this approach was determined to give the correct classification of calcification status 95% of the time, with approximately equal numbers of non-calcified nodules incorrectly classified as calcified and vice versa. One of ordinary skill in the art would recognize in light of the present disclosure that other values percentages and densities may be used for making a determination, and that the method is not limited to the illustrative examples set forth herein.

The output of the system for growing nodule detection is a list of locations where the system has determined 105 that:

a) There is a nodule present in the later scan;

b) The nodule is not calcified; and

c) The nodule was at least 8.8 mm³ smaller in the prior scan.

The threshold for determining that growth has occurred can be adjusted according to user preference and changes in scan parameters, such as higher or lower resolution data.

To test the system's ability to detect growing nodules, an anonymized retrospective study was conducted. Ten patients were selected for whom at least 2 scans were available. Each scan was performed with 1 mm collimation and 1.25 mm reconstructions every 1 mm. The in-plane resolution averaged 0.58 mm with a range of 0.49 to 0.74 mm. The scans were acquired with either low dose (15-40 mAs) or standard dose (80-120 mAs). In most cases the patient received low dose in one scan and standard dose in the other. The median number of days between patients scans was 417 days, with a range of 116 to 539 days. The data characteristics are summarized in Table 1.

TABLE 1
Characteristics of 10 tested patient scans

| | Median | Minimum | Maximum |
|---|---|---|---|
| Radiation dose (mAs) | 40 | 15 | 120 |
| Reconstruction interval (mm) | 1.0 | 1.0 | 1.0 |
| In-plane resolution (mm) | 0.57 | 0.49 | 0.74 |
| Interval between scans (days) | 417 | 116 | 539 |

Two dedicated chest radiologists examined the later of each patient's scan, using advanced soft-copy reading tools. These tools include cartwheel projections (e.g., as described in U.S. patent application Ser. No. 20020028006, entitled Interactive Computer-Aided Diagnosis Method and System for Assisting Diagnosis of Lung Nodules in Digital Volumetric Medical Images, filed Apr. 23, 2001, incorporated herein by reference in its entirety), 3D shaded surface displays (SSD), sliding axial images, and sliding maximum intensity projections (MIP). The readers were instructed to find and mark all focal abnormalities, including not only nodules but also scars.

After performing their own examinations, the radiologists reviewed the results of the growing nodule detection system. By consensus, they classified each computer detection as corresponding to a nodule, a non-nodule abnormality (such as a scar), or a false positive corresponding to normal lung tissue.

The correct matching location in the prior scan was found manually for each nodule candidate, and the volume of the nodule in each scan was determined using commercially available volume measurement software (LungCARE, Siemens, Forchheim, Germany). From these measurements the true change in volume of each nodule was calculated. In the end, the results of the growing nodule detection system were classified into one of three classes:

Class 1) Nodule or other focal abnormality that had actually exhibited growth above the threshold;

Class 2) Nodule or other abnormality that had not grown since the prior scan Class; and

3) Normal lung tissue.

Classes 1 and 2 may be further sub-divided into nodules and non-nodular abnormalities.

The raw nodule detection module generated a list of 98 nodule candidates in the later scans of the 10 patients. The median number of nodule candidates was 6.5 per patient with a range of 1 to 29. The matching module predicted match locations for all 98 candidates, and the segmentation module generated a volume estimate for each candidate and its match.

The majority of processing time for the growing nodule detection system is consumed by the first module for detecting nodule candidates 101. On a computer with a 2 gigahertz processor and 2 gigabytes of memory, the time to complete the first stage averaged 3.6 minutes. The follow-up module requires about 15 seconds per patient for initialization, and then a little less than 1 second for each candidate to be matched. The segmentation module also averages a little less than one second for each nodule volume computation, and with the same time needed for determining the volume at the matching location. Thus for the median patient with 6.5 nodule candidates, the total processing time is approximately 4.2 minutes to detect growing nodule candidates.

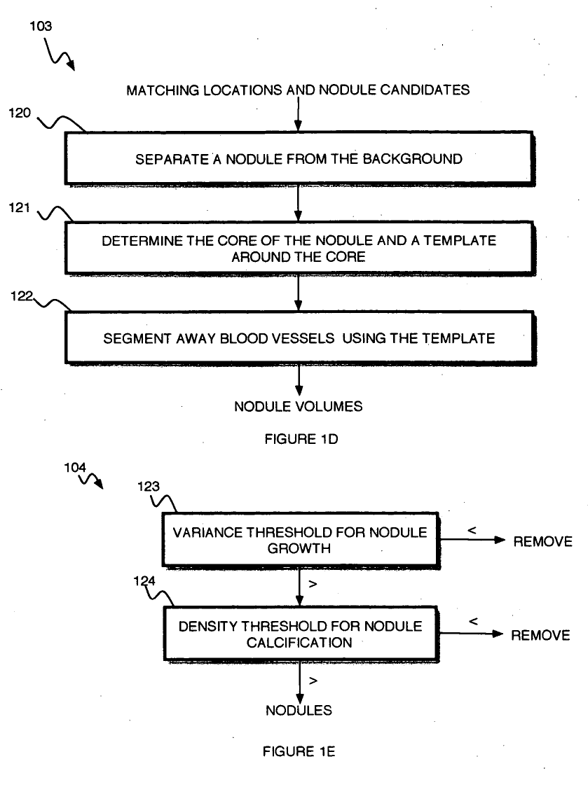

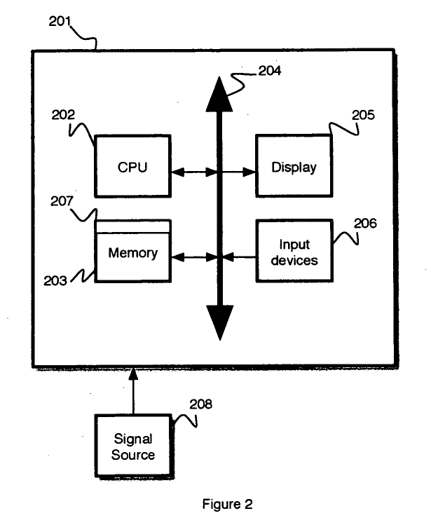

The growing nodule system determined that 18 of the 98 (18%) initial nodule candidates in the 10 patients were possibly growing nodules. The median number of growing nodule candidates detected per patient was 2, with a range of 0 to 5. 15 of the 98 (15%) initial nodule candidates were classified by the system as calcified and thus not candidates for growth. The remaining 65 (66%) of the initial candidates were classified by the system as not having grown sufficiently since the prior scan to warrant special attention. These results are summarized in Table 2 and FIG. 4A.

TABLE 2
Number of nodule candidates and growing nodule candidates
in 10 patients

| | | Per patient | | |
|---|---|---|---|---|
| | Total | Median | Minimum | Maximum |
| Initial nodule candidates | 98 | 6.5 | 1 | 29 |
| Growing nodule candidates | 18 | 2 | 0 | 5 |

7 of the 18 (39%) growing nodule candidates corresponded to validated abnormalities that had exhibited significant growth since the prior scan. The 7 true positive detections were divided into 4 nodules and 3 non-nodular abnormalities such as scars. An additional 9 (50%) of the growing nodule candidates corresponded to validated abnormalities, but these were judged not to have grown significantly since the prior scan. The 9 non-growing abnormalities were divided into 5 nodules and 4 non-nodular abnormalities. 2 (11%) of the growing nodule candidates corresponded to structures that were judged to be normal lung tissue. These results are summarized in FIG. 4B.

Of the 7 true positive growing abnormalities that were detected by the system, the median of the validated diameters at the later scan was 6.2 mm with a range of 4.0 to 9.0 mm. 4 of the 7 true growing abnormalities found by the system are considered “newly appearing” as they could not be retrospectively located in the prior scan. The median diameter of the new abnormalities was 6.4 mm with a range of 4.0 to 9.0 mm. The other 3 detected growing abnormalities could be located in the prior scan.

Four of the 7 detected true growing abnormalities had not been marked by either of the radiologists during their initial examination of the patient data. Both readers had marked the remaining 3 true positives. The median diameter of the overlooked abnormalities was 5.4 mm with a range of 4.0 to 6.2 mm. These results are summarized in Table 3.

TABLE 3
Characteristics of validated growing abnormalities

| | Diameter at later scan (mm) | | | Change in volume (mm³) | | |
|---|---|---|---|---|---|---|
| | Median | Minimum | Maximum | Median | Minimum | Maximum |
| 7 growing abnormalities | 6.2 | 4.0 | 9.0 | 15.4 | 10.5 | 93.3 |
| 4 new abnormalities | 6.4 | 4.0 | 9.0 | 41.3 | 15.0 | 93.3 |
| 4 overlooked abnormalities | 5.4 | 4.0 | 6.2 | 15.2 | 10.5 | 62.8 |

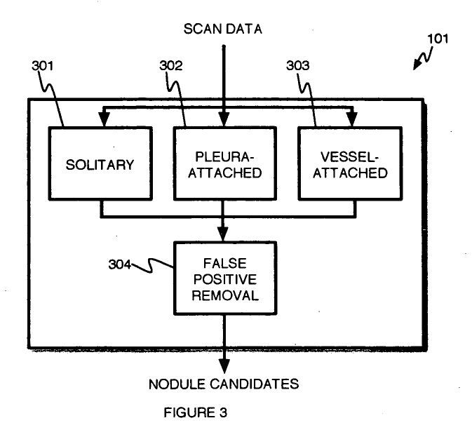

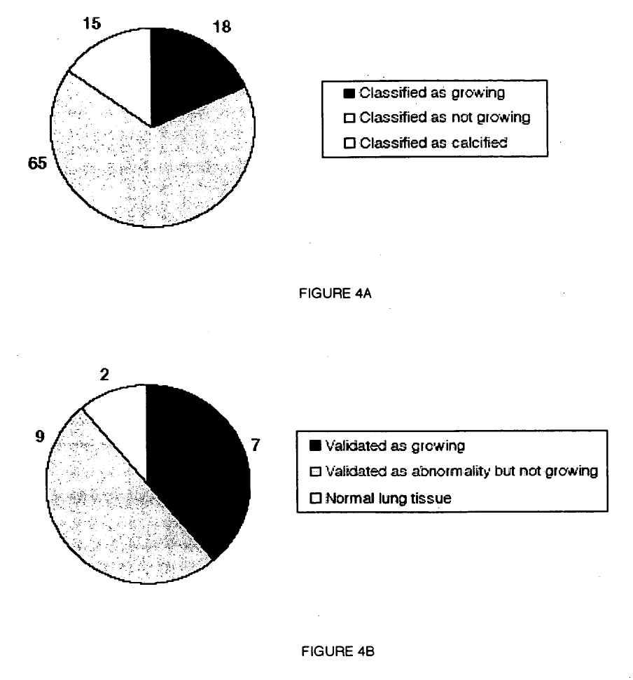

FIGS. 5A-5D show a new nodule that was automatically detected by the system and automatically determined as not being present in the prior scan. The arrow 501 indicates the automatically detected nodule in FIG. 5A. The arrow 501 indicates the automatically matched location in FIG. 5B. Both scans are shown with a MIP to make it more obvious that the surrounding vessels are the same, but the nodule is absent from the earlier scan. This nodule was manually measured as 9.0 mm in diameter at the later scan.

FIG. 5C illustrates an automatic segmentation result for nodule 503 (light gray) with surrounding structures 504 (dark gray). FIG. 5D illustrates automatic segmentation result for match location finds no nodule, only surrounding structures.

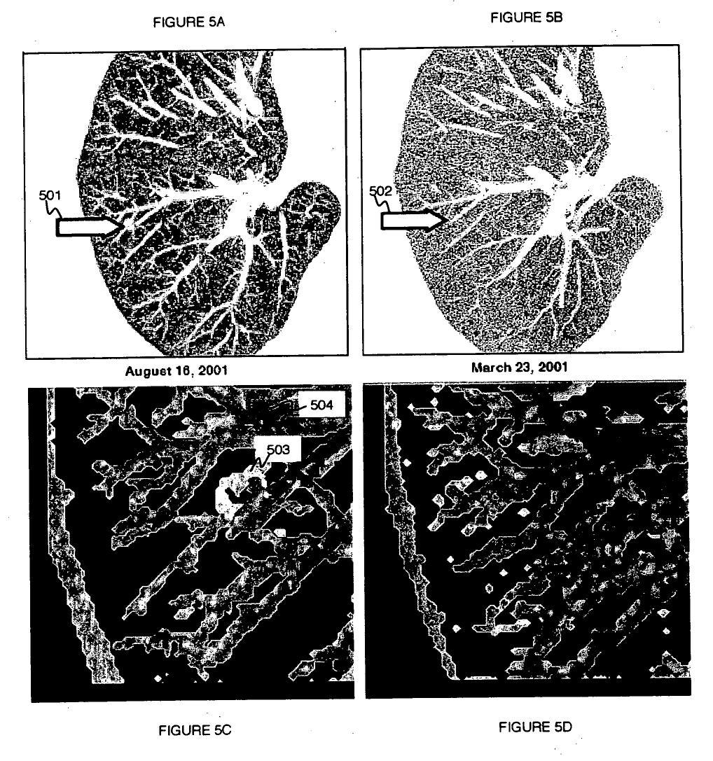

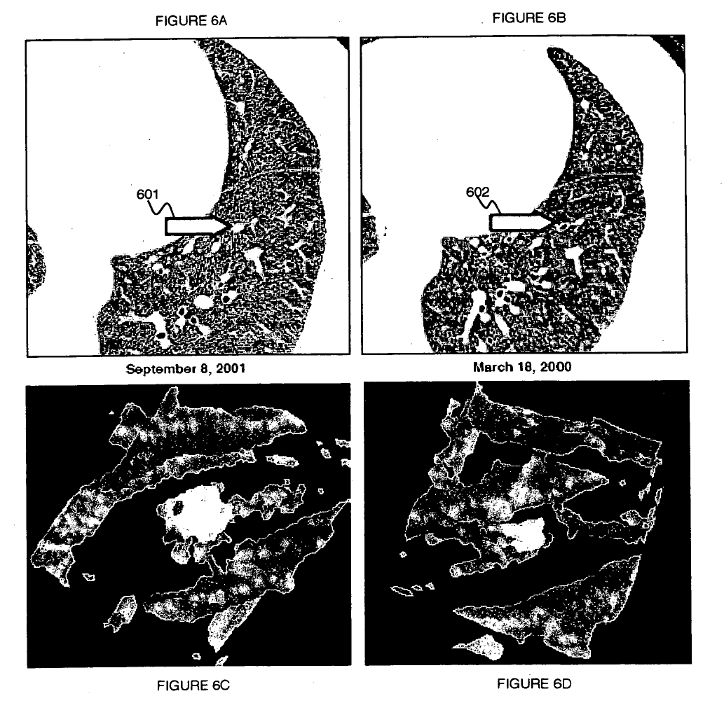

FIGS. 6A-6D show an automatically detected growing nodule that was not prospectively identified by either of the readers during their examinations of the later dataset. Due to the central location, the axial view of this nodule shows a very similar size and shape as the nearby vessels. In the earlier study the nodule is so small as to be indistinguishable from noise.

FIG. 6A shows a position of nodule 601 in later study. FIG. 6B shows a corresponding nodule location 602 in earlier study. FIG. 6C illustrates an automatic segmentation of nodule in later study. FIG. 6D illustrates an automatic segmentation of nodule in earlier study.

The system and method makes use of independent modules for nodule detection 101, matching 102, segmentation 103, and classification 104. Improvements to any of these individual modules can be readily incorporated into the larger system and can be expected to give an improvement in the ability to detect growing nodules. In addition, the reasoning in the system and method can be made more sophisticated to incorporate additional types of evidence. For example, the automatic nodule detection module 101 outputs a confidence value for each candidate in addition to the coordinates. These confidence values may be incorporated into the reasoning module 104. In addition the nodule matcher 102 and nodule segmenter 103 may both be modified to output confidence values, by reporting the determined correlation coefficients used to determine the match location and the optimal segmentation template. In this way the overall system for automatic detection of growing nodules may be made more robust.

Having described embodiments for a system and method for automatically detecting growing nodules, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

1. A method for detecting a nodule in volumetric medical image data comprising:
detecting a nodule candidate in a later scan;
matching a location of the nodule candidate in the later scan to a location of the nodule candidate in an earlier scan, wherein the earlier and later scans are of the same patient;
segmenting the nodule candidate in the earlier and later scans;
comparing volumes from each segmentation; and
determining a growing nodule, wherein the nodule is determined to be larger or newly appeared in the later scan as compared to the earlier scan.

2. The method of claim 1, wherein detecting the nodule candidate in the later scan comprises:
determining voxels in the later scan with densities corresponding to solid tissue as seed points;
determining a threshold for segmenting the seed points from a background in the later scan; and
comparing the seed points to known parameters of nodules to determine the presence of the nodule candidate.

3. The method of claim 1, wherein detecting the nodule candidate in the later scan comprises:
determining seed points by principal components analysis;
performing a volume projection to reduce the data dimension of the seed points from three to one; and
comparing the seed points to known parameters of nodules to determine the presence of the nodule candidate.

4. The method of claim 1, wherein matching the location of the nodule candidate in the later scan to the location of the nodule candidate in the earlier scan comprises:
determining an area of a lung on a 2D slice in each of the earlier and the later scan;
determining a curve for the set of lung areas for the earlier scan and a cruve for the set of lung areas for the later scan;
determining a linear equation for fitting a curve for the earlier and a curve of later scan;
determining an X, Y, or Z displacement in the earlier scan according to an X, Y, or Z displacement in the later scan according to the curve; and
determining the location of the nodule candidate in the earlier scan from the location of the nodule candidate in the later scan, wherein the location is an (x,y,z) coordinate.

5. The method of claim 4, further comprising:
selecting the location in earlier scan is to be refined;
forming surface maps around the location in the earlier scan and the location in the later scan; and
determining a new (x,y,z) coordinate in the earlier scan having a surface map determined to match the surface map of the later scan more closely than the location in the earlier scan previously determined.

6. The method of claim 1, wherein segmenting the nodule candidate in the earlier and later scans comprises:
separating the nodule candidate from a background;
determining a core of the nodule;
determining a template around the core; and
segmenting the scan according to the template.

7. The method of claim 1, further comprising:
determining a density of each nodule candidate; and
removing nodule candidates from the list of growing nodule candidates determined to have a density above a predetermined density threshold.

8. The method of claim 1, further comprising:
determining a size variance for each nodule candidate between the earlier scan and the later scan; and
removing nodule candidates from the list of growing nodule candidates determined to have a size variance less than a predetermined size variance threshold.

9. A program storage device readable by machine, tangibly embodying a program of instructions executable by the machine to perform method steps for detecting a nodule in volumetric medical image data, the method steps comprising:
detecting a nodule candidate in a later scan;
matching a location of the nodule candidate in the later scan to a location of the nodule candidate in an earlier scan, wherein the earlier and later scans are of the same patient;
segmenting the nodule candidate in the earlier and later scans;
comparing volumes from each segmentation; and
determining a growing nodule, wherein the nodule is determined to be larger or newly appeared in the later scan as compared to the earlier scan.

10. A system for detecting a nodule in volumetric medical image data comprising:
a nodule candidate detection module, detecting a nodule candidate in a later scan;
a matching module, matching a location of the nodule candidate in the later scan to a location of the nodule candidate in an earlier scan, wherein the earlier and later scans are of the same patient; and
a segmentation module, segmenting the nodule candidate in the earlier and later scans and comparing volumes from each segmentation, wherein a nodule is determined to be present upon determining the nodule candidate to be larger or newly appeared in the later scan as compared to the earlier scan.

11. The system of claim 10, wherein the nodule detection module comprises:
a solitary module detecting solitary nodules;
a pleura-attached module detecting pleura-attached nodules; and
a vessel attached module detecting vessel-attached nodules.

12. The system of claim 11, further comprising a false-positive module for removing false positive results from the list of nodule candidates as determined by one or more of the solitary module, the pleura-attached module and the vessel attached module.

13. The system of claim 10, further comprising a classification module for classifying nodule candidates of the segmentation module.

14. The system of claim 13, wherein the classification module determines a density of each nodule candidate, and removes nodule candidates from the list of growing nodule candidates determined to have a density above a predetermined density threshold.

15. The method of claim 13, wherein the classification module determines a size variance for each nodule candidate between the earlier scan and the later scan and removes nodule candidates from the list of growing nodule candidates determined to have a size variance less than a predetermined size variance threshold.

16. A method for classifying nodule candidates comprising:
receiving a nodule candidate;
determining a size variance on the nodule candidate between at least two scans taken at different times;
classifying the nodule candidate as a nodule of interest upon determining the size variance to be greater than a threshold;
determining a density of the nodule candidate in the at least two scans; and
classifying the nodule candidate as a nodule of interest upon determining the density of the nodule candidate to be less than a predetermined density threshold in the at least two scans.
